(19) United States
(12) Patent Application Publication
(10) Pub. No.: US 2026/0163043 A1
(43) Pub. Date: Jun. 11, 2026

(54) SOLID OXIDE CELL AND SOLID OXIDE CELL STACK

(71) Applicant: SAMSUNG ELECTRO-MECHANICS CO., LTD., Suwon-si (KR)

(72) Inventor: A Reum JUN, Suwon-si (KR)

(73) Assignee: SAMSUNG ELECTRO-MECHANICS CO., LTD., Suwon-si (KR)

(21) Appl. No.: 19/318,790

(22) Filed: Sep. 4, 2025

(30) Foreign Application Priority Data
Dec. 11, 2024 (KR) 10-2024-0183936

(51) Int. Cl. H01M 8/1286; H01M 8/0206; H01M 8/0247; H01M 8/12; H01M 8/1226; H01M 8/2428

(52) U.S. Cl. CPC H01M 8/1286; H01M 8/0206; H01M 8/0247; H01M 8/1226; H01M 8/2428; H01M 2008/1293

(57) ABSTRACT

A solid oxide cell includes a support including a support plate and a leg portion supporting the support plate at an outer edge of the support plate, and a unit cell disposed opposite the leg portion on the support plate and including a fuel electrode, an air electrode, and an electrolyte disposed between the fuel electrode and the air electrode, in which, when a thickness direction of the support plate is a first direction, the outer edge of the unit cell overlaps the leg portion in the first direction.

### CROSS-REFERENCE TO RELATED APPLICATION(S)

This application claims benefit of priority to Korean Patent Application No. 10-2024-0183936 filed on Dec. 11, 2024 in the Korean Intellectual Property Office, the disclosure of which is incorporated herein by reference in its entirety.

### TECHNICAL FIELD

The present disclosure relates to a solid oxide cell and a solid oxide cell stack.

A solid oxide fuel cell (SOFC) and a solid oxide electrolysis cell (SOEC) include a cell comprised of a fuel electrode, an air electrode, and a solid electrolyte having oxygen ion conductivity, in which the cell may be referred to as a solid oxide cell. The solid oxide cell produces electrical energy through an electrochemical reaction or produces hydrogen by electrolyzing water through a reverse reaction of the solid oxide fuel cell. Compared to other types of fuel cells or water electrolysis cells, such as a phosphoric acid fuel cell (PAFC), an alkaline fuel cell (AFC), a polymer electrolyte fuel cell (PEMFC), and a direct methanol fuel cell (DMFC), the solid oxide cell has low overvoltage and low irreversible loss due to its low activation polarization, leading to high efficiency. In addition, the solid oxide cell has a wide range of fuel options as it may use not only hydrogen but also carbon or hydrocarbon-based fuels, and has the advantage of not requiring expensive precious metals as electrode catalysts because the reaction rate at the electrode is high.

In the case of the electrochemical device such as the solid oxide cell, it is common to use a stack structure in which a unit cell is disposed between a pair of separators. In the stack structure, there is a problem in that it is difficult to replace cells in units of cells when a problem occurs in a cell during the driving process.

### SUMMARY

As aspect of the present disclosure is to implement a solid oxide cell that may be capable of efficient maintenance when used in a stack structure. In addition, the present disclosure is to implement a solid oxide cell stack that may be capable of reducing the number of separators compared to the conventional one.

According to some aspects of the present disclosure, a solid oxide cell includes a support including a support plate and a leg portion supporting the support plate at an outer edge of the support plate, and a unit cell disposed opposite the leg portion on the support plate and including a fuel electrode, an air electrode, and an electrolyte disposed between the fuel electrode and the air electrode, in which, when a thickness direction of the support plate is a first direction, the outer edge of the unit cell overlaps the leg portion in the first direction.

The leg portion may connect an outer region of the support plate as a whole to form an integrated structure.

The support plate and the leg portion may be an integrated structure.

The support may be a metal support.

The support plate may include a plurality of through-holes.

At least one outer edge of the fuel electrode and the air electrode may overlap the leg portion in the first direction.

The unit cell may include the fuel electrode, the electrolyte, and the air electrode sequentially arranged on one surface of the support plate.

The electrolyte may cover a side surface of the fuel electrode.

The electrolyte may cover at least a portion of a side surface of the support plate.

The electrolyte may not cover a side surface of the support plate.

According to another aspect of the present disclosure, a solid oxide cell includes a support including a support plate and a leg portion supporting the support plate at an outer edge of the support plate, and a unit cell disposed opposite to the leg portion on the support plate and including a fuel electrode, an air electrode, and an electrolyte disposed between the fuel electrode and the air electrode, in which the leg portion connects an outer region of the support plate as a whole to form an integrated structure.

According to another aspect of the present disclosure, a solid oxide cell stack includes a plurality of solid oxide cells, and a connecting portion coupled to the plurality of solid oxide cells, in which the plurality of solid oxide cells include a support including a support plate and a leg portion supporting the support plate at an outer edge of the support plate, and a unit cell disposed opposite the leg portion on the support plate and including a fuel electrode, an air electrode, and an electrolyte disposed between the fuel electrode and the air electrode, and when a thickness direction of the support plate is a first direction, the outer edge of the unit cell overlaps the leg portion in the first direction.

The connecting portion may include a ring-shaped coupling portion coupled to the plurality of solid oxide cells and a flow path connected to the coupling portion.

The leg portion of the solid oxide cell may be fitted to the coupling portion.

The coupling portion may be disposed on an outer side of the leg portion of the solid oxide cell.

The coupling portion may have a lower coefficient of thermal expansion than the leg portion of the solid oxide cell.

The coupling portion may be disposed on an inner side of the leg portion of the solid oxide cell.

The coupling portion may have a higher coefficient of thermal expansion than the leg portion of the solid oxide cell.

The plurality of solid oxide cells may include first and second solid oxide cells, and the leg portion of the first solid oxide cell and the leg portion of the second solid oxide cell may be arranged adjacent to each other, facing each other.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is an exploded perspective view schematically illustrating a solid oxide cell according to an example embodiment of the present disclosure;

FIG. 2 is a cross-sectional view schematically illustrating one region of the solid oxide cell;

FIG. 3 is a cross-sectional view schematically illustrating one region of a solid oxide cell according to another example;

FIG. 4 is a cross-sectional view schematically illustrating one region of a solid oxide cell according to another example;

FIG. 5 is a cross-sectional view schematically illustrating one region of a solid oxide cell stack;

FIG. 6 is a perspective view illustrating a connecting portion that may be employed in the solid oxide cell stack;

FIG. 7 is an example of the solid oxide cell being separated from a connecting portion in the solid oxide cell stack; and

FIG. 8 is a cross-sectional view illustrating one region of a solid oxide cell stack according to another example.

### DETAILED DESCRIPTION

Hereinafter, example embodiments will be described in detail with reference to the accompanying drawings. However, example embodiments may be modified in various other forms, and the scope of the present disclosure is not limited to example embodiments to be described below. Further, example embodiments are provided in order to more completely describe the present disclosure to those skilled in the art. In the drawings, the shapes and dimensions may be exaggerated for clarity, and the same reference numerals will be used throughout to designate the same or like components.

In the drawings, parts not related to the description are omitted in order to clearly describe the present disclosure, a thickness has been enlarged in order to clearly express several layers and areas, and the same components having the same function within the scope of the same idea are described using the same reference numerals. Furthermore, throughout the present specification, unless explicitly described to the contrary, “comprising” any components will be understood to imply the inclusion of other elements rather than the exclusion of any other elements.

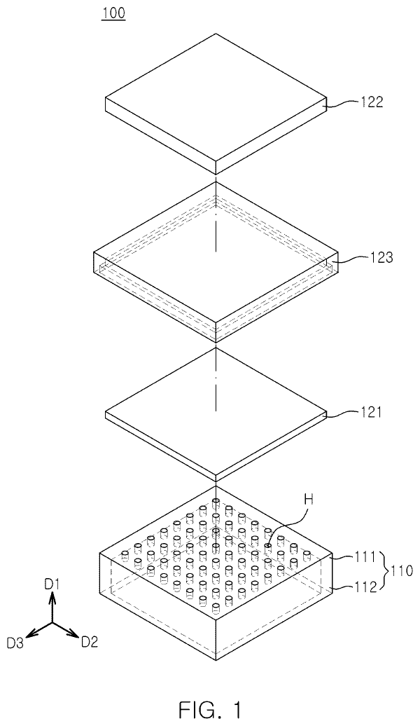

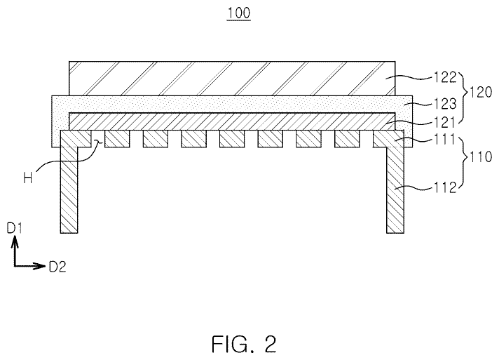

FIG. 1 is an exploded perspective view schematically illustrating a solid oxide cell according to an example embodiment of the present disclosure. FIG. 2 is a cross-sectional view schematically illustrating one region of the solid oxide cell.

Referring to FIGS. 1 and 2, a solid oxide cell 100 according to an example embodiment of the present disclosure includes a support 110 including a support plate 111 and a leg portion 112, and a unit cell 120 as main components. Here, when a thickness direction of the support plate 111 is referred to as a first direction D1, the unit cell 120 has a structure in which an outer edge of the unit cell 120 overlaps the leg portion 112 in the first direction D1. Here, second and third directions D2 and D3 may be defined as directions that are perpendicular to the first direction D1 and are perpendicular to each other. As in the present example embodiment, since the outer edge of the support 110 is provided with the leg portion 112 that overlaps the unit cell 120, the solid oxide cell 100 may be implemented in a shape similar to a box or a case. As will be described later, the solid oxide cell 100 having this shape may be easily separated and combined into units of cells 100 when applied to a stack structure, enabling effective maintenance. In addition, regardless of this overlapping structure, the leg portion 112 forms an integrated structure that connects the outer region of the support plate 111 as a whole, so that the leg portion 112 may be implemented in a shape similar to a box or a case, which may be mentioned as one of the main features of the present example embodiment.

Hereinafter, the components of the solid oxide cell 100 will be described in detail. The solid oxide cell 100 may be used as both a fuel cell and a water electrolysis cell, and in the case of the water electrolysis cell mode, a reaction opposite to that in the case of the fuel cell will occur at the fuel electrode 110 and air electrode 130 of the solid oxide cell 120. Specifically, when the solid oxide cell 100 is a fuel cell, for example, water generation or an oxidation reaction of a carbon compound due to the oxidation of hydrogen may occur at the fuel electrode 110, and an oxygen ion generation reaction due to the decomposition of oxygen may occur at the air electrode 130. When the solid oxide cell 100 is the water electrolysis cell, a reaction opposite thereto may occur, and for example, hydrogen gas may be generated at the fuel electrode 110 due to the reduction reaction of water, and oxygen may be generated at the air electrode 130. In addition, as another example, in the case of the fuel cell, a decomposition reaction (hydrogen ion generation) of hydrogen may occur at the fuel electrode 110, and oxygen and hydrogen ions may combine at the air electrode 130 to generate water. In the case of the water electrolysis cell, a decomposition reaction (hydrogen and oxygen ion generation) of water may occur at the fuel electrode 110, and oxygen may be generated at the air electrode 130. In addition, ions may move to the fuel electrode 110 or the air electrode 130 in the electrolyte 120.

As described above, the support 110 includes the support plate 111 and the leg portion 112. Here, the leg portion 112 may support the support plate 111 at the outer edge of the support plate 111. In this case, the support 110 may provide mechanical strength while supporting the unit cell 120. The support 110 may be a metal support, and may include, for example, an iron-based alloy, more specifically, a chromium-iron-based alloy. In addition, the support 110 may be implemented using a material used in the art. As described above, the leg portion 112 may connect the outer region of the support plate 111 to form an integrated structure, and an inner side of the leg portion 112 in the support 110 may be empty as in the illustrated form. Accordingly, the support 110 may obtain a box or case structure as a whole. In addition, the support plate 111 and the leg portion in the support 110 may be an integrated structure. In addition, the support plate 111 may include a plurality of through-holes H, and fluid may enter and exit through a through-hole H.

The unit cell 120 may be disposed on a surface of the support plate 111 that is opposite to a surface on which the leg portion 112 is disposed, and may include a fuel electrode 121, an air electrode 122, and an electrolyte 123 disposed between the fuel electrode 121 and the air electrode 122. In this case, the unit cell 120 may include the fuel electrode 121, the electrolyte 123, and the air electrode 122 sequentially arranged on one surface of the support plate 111. As described above, the outer edge of the unit cell 120 may overlap the leg portion 112 of the support 110 in the first direction D1. That is, the unit cell 120 may be disposed to a side surface of the support such that the unit cell 120 extends in downwardly in the D1 direction. As a specific example, the outer edge of at least one of the fuel electrode 121 or the air electrode 122 of the unit cell 120 may overlap the leg portion 112 in the first direction D1. In addition, the outer edge of the electrolyte 123 may also overlap the leg portion 112 in the first direction D1, and in some example embodiments of the present disclosure, the fuel electrode 121, the electrolyte 123, and the air electrode 122 all may have a structure in which their outer edges overlap the leg portion 112 in the first direction D1.

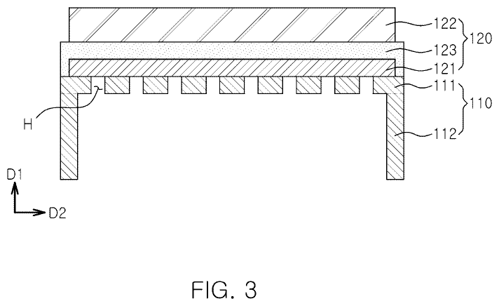

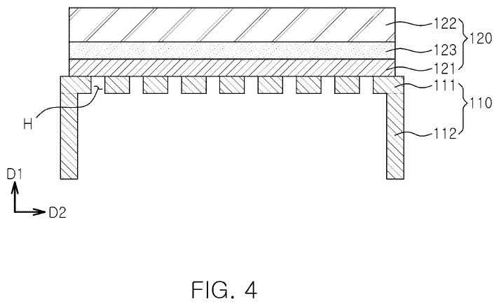

As illustrated in FIG. 2, the electrolyte 123 may cover a side surface of the fuel electrode 121. Accordingly, an interface between the fuel electrode 121 and the electrolyte 123 may increase, thereby improving the electrochemical reaction efficiency. In addition, the electrolyte 123 may be further extended to cover at least a portion of a side surface of the support plate 111, and in this case, the structural stability of the solid oxide cell 100 may be improved. In contrast, as in the modified example of FIG. 3, the electrolyte 123 may be formed in a range that does not cover the side surface of the support plate 111 so as to be advantageous for miniaturization. Also, as in the modified example of FIG. 4, the electrolyte 123 may not cover the side surface of the fuel electrode 121.

Specifically describing the materials constituting the fuel electrode 110, the electrolyte 120, and the air electrode 130, first, the fuel electrode 110 may include a cermet layer including a metal-containing phase and a ceramic phase. Here, the metal-containing phase may include a metal catalyst such as at last one selected from the group consisting of nickel (Ni), cobalt (Co), copper (Cu), and an alloy thereof that acts as an electron conductor. The metal catalyst may be in a metal state or an oxide state. The ceramic phase of the fuel electrode 121 may include at least one selected from the group consisting of gadolinia-doped ceria (GDC), samaria-doped ceria (SDC), yttria-doped ceria (YDC), scandia-stabilized zirconia (SSZ), and ytterbia-ceria-scandia-stabilized zirconia (YbCSSZ), etc. The air electrode 122 may include an electrically conductive material, such as an electrically conductive perovskite material such as lanthanum strontium manganite (LSM). Other conductive perovskites, such as lanthanum strontium cobalt (LSC), lanthanum strontium cobalt manganese (LSCM), lanthanum strontium cobalt ferrite (LSCF), lanthanum strontium ferrite (LSF), La_{0.85}Sr_{0.15}Cr_{0.9}Ni_{0.1}O₃ (LSCN), or a metal such as Pt, may also be used. In some example embodiments, the air electrode 122 may include a mixture of an electrically conductive material and an ionically conductive ceramic material. For example, the air electrode 122 may include about 10 wt % to about 90 wt % of electrically conductive material (e.g., LSM, etc.) and about 10 wt % to about 90 wt % of ionically conductive material. Here, the ionically conductive material may include a zirconia-based and/or ceria-based material. The electrolyte 123 may include stabilized zirconia. Specifically, the electrolyte 123 may include at least one selected from the group consisting of smaydia-stabilized zirconia (SSZ), yttria-stabilized zirconia (YSZ), smaydia-ceria-stabilized zirconia (SCSZ), smaydia-ceria-yttria-stabilized zirconia (SCYSZ), and smaydia-ceria-ytterbia-stabilized zirconia (SCYbSZ), etc.

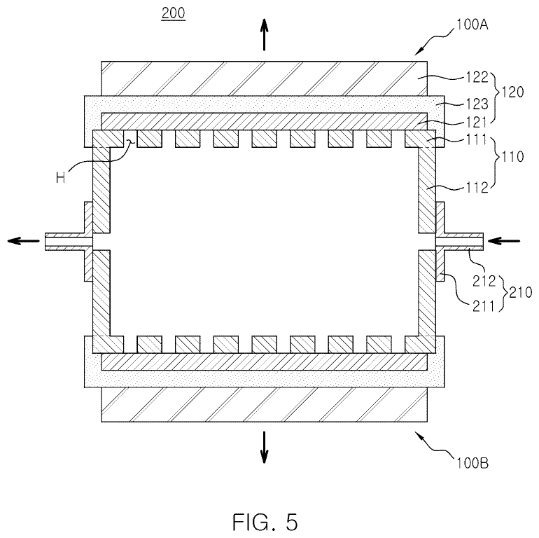

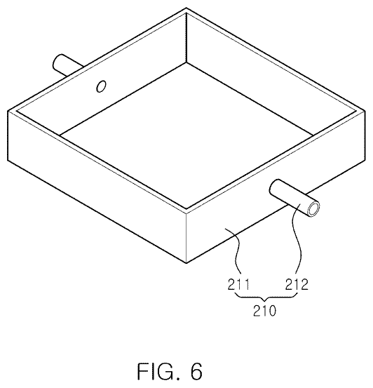

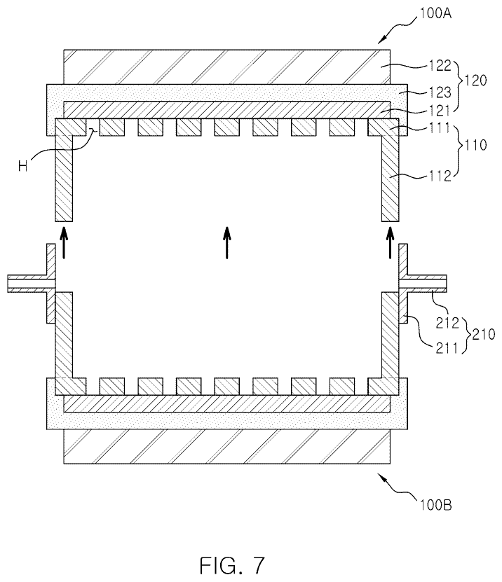

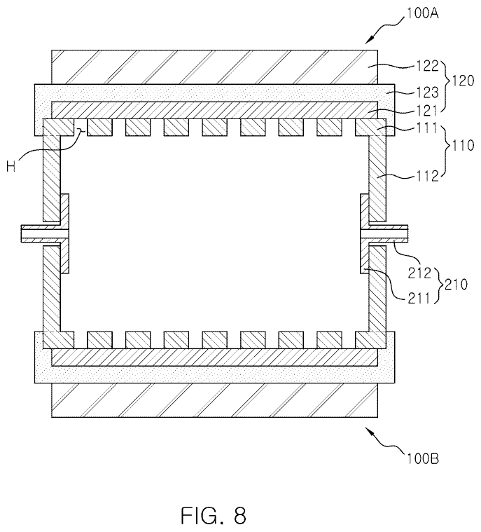

A solid oxide cell stack that may be configured to include the solid oxide cell described above is described with reference to FIGS. 5 through 8. FIG. 5 is a cross-sectional view schematically illustrating one region of a solid oxide cell stack. FIG. 6 is a perspective view illustrating a connecting portion that may be employed in the solid oxide cell stack, and FIG. 7 illustrates an example embodiment of the present disclosure in which the solid oxide cell is separated from the connecting portion in the solid oxide cell stack. In addition, FIG. 8 is a cross-sectional view illustrating one region of a solid oxide cell stack according to another example.

Referring to FIG. 5 and FIG. 6, a solid oxide cell stack 200 includes a plurality of solid oxide cells 100A and 100B and a connecting portion 210. Here, the plurality of solid oxide cells 100A and 100B may be employed in the structure described above. That is, the plurality of solid oxide cells 100A and 100B may include the support 110 including the support plate 111 and the leg portion 112, and the unit cell 120. Here, when the thickness direction of the support plate 111 is referred to as the first direction D1, the unit cell has a structure in which the outer edge of the unit cell 120 overlaps the leg portion 112 in the first direction D1. In addition, regardless of the overlap structure, the leg portion 112 may be implemented as an integrated structure that connects the outer region of the support plate 111 as a whole.

The connecting portion 210 may be a component that replaces a conventional separator and may be made of or may include an elastic material an elastic metal material. The connecting portion 210 may include a ring-shaped coupling portion 211 coupled to the plurality of solid oxide cells 100A and 100B and a flow path 212 connected to the coupling portion 211. When the solid oxide cell stack 200 functions as a water electrolysis cell, as can be seen in the flow of arrows in FIG. 5, H₂O may be supplied and H₂ may be discharged through the flow path 212, and O₂ may be discharged through the air electrode 122. The plurality of solid oxide cells may include the first and second solid oxide cells 100A and 100B, which may be arranged in opposite directions to provide a space for the flow of fluid. Specifically, the leg portion 112 of the first solid oxide cell 100A and the leg portion 112 of the second solid oxide cell 100B may be arranged adjacent to each other, to face each other. The leg portions 112 of the solid oxide cells 100A and 100B may be fitted to the coupling portion 211, and in this case, the solid oxide cells 100A and 100B may be easily coupled to the coupling portion 211 or easily separated from the coupling portion 211 as illustrated in FIG. 7, which may be advantageous in terms of maintenance.

Describing a specific coupling method of the solid oxide cells 100A and 100B and the connecting portion 210, first, as illustrated in FIG. 5, the coupling portion 211 may be disposed on the outer side of the leg portion 112 of the solid oxide cells 100A and 100B. When the coupling portion 211 is disposed on the outer side of the leg portion 112 of the solid oxide cells 100A and 100B, the coupling portion 211 may have a lower coefficient of thermal expansion than the leg portion 112 of the solid oxide cells 100A and 100B. When driven at a high temperature, the leg portion 112 may be expanded relatively more, so the coupling and sealing with the coupling portion 211 may be maintained. For this purpose, the coupling portion 211 may be made of an elastic material or may include an elastic material. In contrast, as in the example embodiment of FIG. 8, the coupling portion 211 may be disposed inside the leg portion 112 of the solid oxide cells 100A and 100B. In this case, the coupling portion 211 may have a higher coefficient of thermal expansion than the leg portion 112 of the solid oxide cells 100A and 100B, and when driven at a high temperature, the coupling portion 211 may expand relatively more, so the coupling and sealing with the leg portion 112 may be maintained. In the case of the solid

oxide cell stack 200 having the above-described structure, the solid oxide cells 100A and 100B may be easily coupled to or separated from the coupling portion 211, which may be advantageous in terms of maintenance. Furthermore, the solid oxide cell stack 200 may not require a separate sealant due to the stable bonding of the solid oxide cells 100A and 100B and the connecting portion 210, which may also be advantageous in terms of efficient maintenance and manufacturing costs.

According to some example embodiments of the present disclosure, the solid oxide cell may be efficiently maintained when used in the stack structure. In addition, it is possible to provide the solid oxide cell stack capable of reducing the number of separators compared to the conventional one.

While example embodiments have been shown and described above, it will be apparent to those skilled in the art that modifications and variations could be made without departing from the scope of the present invention as defined by the appended claims.

What is claimed is:

1. A solid oxide cell, comprising:
a support including a support plate and a leg portion supporting the support plate extending from the support plate in a first direction at an outer edge of the support plate, the first direction being a thickness direction of the support plate; and
a unit cell disposed on a surface of the support plate that is opposite to a surface on which the leg portion is disposed, and including a fuel electrode, an air electrode, and an electrolyte disposed between the fuel electrode and the air electrode,
wherein, the outer edge of the unit cell overlaps the leg portion in the first direction.

2. The solid oxide cell according to claim 1, wherein the leg portion connects an outer region of the support plate as a whole to form an integrated structure.

3. The solid oxide cell according to claim 1, wherein the support plate and the leg portion are an integrated structure.

4. The solid oxide cell according to claim 1, wherein the support is a metal support.

5. The solid oxide cell according to claim 1, wherein the support plate includes a plurality of through-holes.

6. The solid oxide cell according to claim 1, wherein at least one outer edge of the fuel electrode and the air electrode overlaps the leg portion in the first direction.

7. The solid oxide cell according to claim 1, wherein the unit cell includes the fuel electrode, the electrolyte, and the air electrode sequentially arranged on one surface of the support plate.

8. The solid oxide cell according to claim 7, wherein the electrolyte covers a side surface of the fuel electrode.

9. The solid oxide cell according to claim 8, wherein the electrolyte covers at least a portion of a side surface of the support plate.

10. The solid oxide cell according to claim 7, wherein the electrolyte does not cover a side surface of the support plate.

11. A solid oxide cell, comprising:
a support including a support plate and a leg portion supporting the support plate at an outer edge of the support plate; and
a unit cell disposed on a surface of the support plate that is opposite to a surface on which the leg portion is disposed, and including a fuel electrode, an air electrode, and an electrolyte disposed between the fuel electrode and the air electrode,
wherein the leg portion connects an outer region of the support plate as a whole to form an integrated structure.

12. A solid oxide cell stack, comprising:
a plurality of solid oxide cells; and
a connecting portion coupled to the plurality of solid oxide cells,
wherein the plurality of solid oxide cells include:
a support including a support plate and a leg portion supporting the support plate at an outer edge of the support plate; and
a unit cell disposed on a surface of the support plate that is opposite to a surface on which the leg portion is disposed, and including a fuel electrode, an air electrode, and an electrolyte disposed between the fuel electrode and the air electrode, and
when a thickness direction of the support plate is a first direction, the outer edge of the unit cell overlaps the leg portion in the first direction.

13. The solid oxide cell stack according to claim 12, wherein the connecting portion includes a ring-shaped coupling portion coupled to the plurality of solid oxide cells and a flow path connected to the coupling portion.

14. The solid oxide cell stack according to claim 13, wherein the leg portion of the solid oxide cell is fitted to the coupling portion.

15. The solid oxide cell stack according to claim 13, wherein the coupling portion is disposed on an outer side of the leg portion of the solid oxide cell.

16. The solid oxide cell stack according to claim 15, wherein the coupling portion has a lower coefficient of thermal expansion than the leg portion of the solid oxide cell.

17. The solid oxide cell stack according to claim 13, wherein the coupling portion is disposed on an inner side of the leg portion of the solid oxide cell.

18. The solid oxide cell stack according to claim 17, wherein the coupling portion has a higher coefficient of thermal expansion than the leg portion of the solid oxide cell.

19. The solid oxide cell stack according to claim 12, wherein the plurality of solid oxide cells include first and second solid oxide cells, and
the leg portion of the first solid oxide cell and the leg portion of the second solid oxide cell are arranged adjacent to each other, facing each other.
